(19) United States
(12) Patent Application Publication
(10) Pub. No.: US 2002/0178432 A1
(43) Pub. Date: Nov. 28, 2002

(54) Method and system for synthesizing a circuit representation into a new circuit representation having greater unateness

(76) Inventors: Hyungwon Kim, San Jose, CA (US); John P. Hayes, Ann Arbor, MI (US)

Correspondence Address: John S. Le Roy, Brooks & Kushman P.C., 22nd Floor, 1000 Town Center, Southfield, MI, 48075-1351, US

(21) Appl. No.: 09/931,131

(22) Filed: Aug. 16, 2001

Related U.S. Application Data
(60) Provisional application No. 60/226,103, filed on Aug. 17, 2000.

(51) Int. Cl. G06F 17/50; G06F 9/45

(52) U.S. Cl. 716/18

(57) ABSTRACT

Method, system and computer-executable code are disclosed for synthesizing a representation of a circuit into a new circuit representation having greater unateness. The invention includes partitioning a circuit representation to obtain a representation of at least one sub-circuit, recursively decomposing the representation of the at least one sub-circuit into a sum-of-products or product-of-sums representation having greater unateness than the representation of the at least one sub-circuit, merging the sum-of-products or product-of-sums representation into the circuit representation to form a new circuit representation, and repeating until a desired level of unateness for the new circuit representation is achieved. Algebraic division is implemented to merge common expressions of the sum-of-products or product-of-sums representations. A zero-suppressed binary decision diagram is implemented to recursively decompose the representation of the sub-circuit.

### CROSS-REFERENCE TO RELATED APPLICATION

This application claims the benefit of U.S. provisional application Serial No. 60/226,103, filed Aug. 17, 2000 and entitled “Method and System for Synthesizing Digital Circuits with Unateness Properties.”

### GOVERNMENT RIGHTS

This invention was made with government support under National Science Foundation Grant Nos. 9503463 and 9872066 and DARPA Grant No. DABT 63-96-C-0074. The government has certain rights in this invention.

### BACKGROUND OF THE INVENTION

1. Field of the Invention

This invention relates to a method and system for synthesizing a circuit representation of a circuit into a new circuit representation having greater unateness.

2. Background Art

The number of transistors that can be fabricated in a single IC has been growing exponentially over the last three decades. A well-known example is the Intel series of microprocessors. Intel's first commercial microprocessor, the 4004, was built with 2,300 transistors in 1971, whereas a recent Intel microprocessor, the Pentium III, introduced in 1999 contains 9.5 million transistors. The clock frequency of the microprocessors also has dramatically increased from the 4004's 0.1 MHZ to the Pentium III's 550MHz. The 1998 International Technology Roadmap for Semiconductors developed by the Semiconductor Industry Association (SIA) predicts that the transistor count and the clock frequency of ICs will grow even faster in the next decade.

It is thus becoming extremely difficult and time-consuming to design all the components in a complex IC from scratch, verify their functional and timing correctness, and ensure that overall performance requirements are met. To solve this challenging problem, a “design reuse” methodology is being widely introduced, which integrates large standardized circuit blocks into a single IC called a system on a chip (SOC). An SOC integrates a set of predesigned “off-the-shelf” blocks to build the entire system on a single chip, just as off-the-shelf IC's have been used to build a system on a board. The SOC methodology allows IC designers to focus on the interfaces linking the predesigned blocks. Thus it saves a tremendous amount of time that the designers would have spent creating all the blocks from scratch, and verifying their correctness. For this reason, the SOC design approach is becoming increasingly popular.

A large portion of the reused blocks in an SOC are intellectual property (IP) circuits, which are also called cores or virtual components, and are often provided by third party vendors. The IP providers typically transfer their designs to SOC designers in a way that hides the key design details of the IP circuits and so protect the IP provider's investment in the IP designs. The IP circuits that have been developed so far cover numerous functions and support many different IC technologies. Additionally, the number and scope of the available IP circuits are rapidly growing.

IP circuits are currently available in three different forms known as hard, soft, and firm. Hard IP circuits are provided in the form of complete layouts that are optimized and verified by the IP providers for a particular IC technology. Therefore, hard IP circuits can save time in all SOC design steps, but cannot be reoptimized by system designers for other technologies. The intellectual property of hard IP circuits includes all the implementation details and is protected by providing the system designers only with the circuit's high-level behavioral or functional specifications. Soft IP circuits are provided in the form of register-transfer level (RTL) descriptions, which define the circuit's behavior using a set of high-level blocks. These blocks can be converted by system designers to lower-level designs at the gate and physical levels. Thus soft IP circuits can be optimized for a variety of IC technologies and performance requirements, while they can save SOC design time in the high-level design and verification steps. Their RTL designs are considered to be the intellectual property contents of soft IP circuits. Finally, firm IP circuits are provided as netlists or gate-level descriptions. They allow the system designers to optimize the IP circuit's physical design such as cell placement and routing for various IC technologies. They provide the major advantages of both hard and soft IP circuits—they save system design time while allowing the flexibility of retargeting the IP circuits at various IC technologies. Both their RTL and gate-level designs are considered to be the intellectual property contents of firm IP circuits. While hard IP circuits are primarily aimed at ASIC designs, some soft and firm IP circuits are aimed at SOCs implemented using field programmable gate array (FPGA) technology.

Although the advancement of IC technology allows extremely large designs to be integrated in a single chip, today's IC technology presents major challenges to the existing design and testing methodologies. For example, testing requirements for complex digital circuits are becoming increasingly tighter. Using traditional processes to synthesize the implementation of digital and other circuits often leads to circuits that are either inefficient in meeting testing requirements (i.e., unreasonably large test sets, etc.) or cannot satisfy design constraints (i.e., delay, area limits, etc.).

The unateness of a circuit has a substantial impact on circuit testability and performance. Unate variables of a circuit representation z are variables that appear only in complemented or uncomplemented form in z's minimal two-level expressions such as sum of products (SOP) or product of sums (POS) expressions; binate variables are non-unate. For example, z₁=a\overline{b}+a\overline{c}+bcd is a minimal SOP expression for the four-variable function z₁, in which a and d are unate, and b and c are binate.

The majority of circuit representations are, in nature, binate, and it is often difficult to synthesize these binate functions into a circuit implementation that can be efficiently tested for manufacturing defects and operate at very high speeds.

For example, a high-speed circuit implementation known as “domino logic” requires that the circuit to be implemented be unate. Therefore, binate circuit functionality to be implemented in domino logic must be decomposed into unate circuit implementations. Similarly, static CMOS logic implementations become efficient if unate circuit implementations are extracted from an original binate circuit prior to implementation. Datapath logic circuits such as adders, subtractors, comparators, and ALUs are good examples of applications where carry generation functions (i.e., unate functions) are extracted from a larger (often binate) function and implemented in high-speed circuit structures.

Another advantage of unate circuit implementations is their relatively small universal test set (i.e., the set of minimal true and maximal false test vectors for a function z). These test vectors have the useful property that they can detect all multiple stuck-at faults in any implementation of z. Universal test sets guarantee a very high coverage of manufacturing defects in a vast range of implementations for given circuit functionality. The universal test sets for binate circuit implementations tend to become excessively large. In addition, the unateness property enables the generation of test vectors from the behavioral functions of circuits before their implementations are actually executed.

Existing functional decomposition processes are not suited to the goal of decomposing a binate circuit representation into a small set of unate subfunctions. One existing functional decomposition process called kernel extraction is aimed at multi-level logic synthesis. The kernels of a circuit representations are defined as f's cube-free primary divisors or quotients. For example, the kernels of f=(a+b+c)(d+e)f+bfg+h include d+e, d+e+g, and a+b+c. This decomposition process employs algebraic division operations with the kernels serving as divisors or quotients to f. Here algebraic division represents f by a logic expression of the form f=p·q+r. The kernels of f can be binate, so f's subfunctions p, q, and r can also be binate. In addition, kernel extraction often leads to an excessive number of subfunctions, and so is not practical for unate decomposition.

Another existing decomposition process is Boole-Shannon expansion, which represents circuit implementation f by xfₓ+\overline{x}f_{\overline{x}} where fₓ is the cofactor of f with respect to x. Cofactor fₓ is defined as the subfunction of f obtained by assigning 1 to variable x in f Boole-Shannon expansion has been widely used for binary decision diagram (BDD) construction, technology mapping and field programmable gate array synthesis. Boole-Shannon expansion is unsuited to the goal of obtaining a small set of unate circuit implementations, however, since it may only make the child functions fₓ and f_{\overline{x}} unate, while always expressing the parent function in a binate form. When applied repeatedly, Boole-Shannon expansion can also produce an unnecessarily large number of subfunctions, as each is created by eliminating only one binate variable at a time.

Finally, a disjoint or disjunctive decomposition represents a boolean function f(X, Y) in the form h(g₁(X₁), g₂(X₂), . . . , gₖ(Xₖ), Y), where X₁, X₂, . . . , Xₖ, and Y are disjoint (i.e., non-overlapping) variable sets. This decomposition is relatively easy to compute, and is sometimes used for logic synthesis problems where the interconnection cost dominates the circuit's overall cost. It has the drawback that many circuit representations cannot be disjointly decomposed, and, like Boole-Shannon expansion, it can make the parent function h binate. Thus, the disjoint decomposition technique is also not appropriate for our unate decomposition goal.

### SUMMARY OF THE INVENTION

One object of the present invention is to provide a method and system for efficiently synthesizing a circuit representation into a new circuit representation (i.e., circuit implementation) having greater unateness. Notably, those of ordinary skill in the relevant art will appreciate that the present invention may be implemented or applied in a variety of circumstances to synthesize circuits beyond those discussed, by way of example, in the preceding Background Art.

One advantage of circuit implementations that possess unateness is their relatively small universal test set (i.e., the set of its minimal true and maximal false test vectors). Universal test sets guarantee a very high coverage of manufacturing defects in a vast range of implementations for a give function. Unlike universal test sets for highly unate circuit implementations, the universal test sets for largely binate circuits tend to become excessively large. In addition, the unateness property enables the generation of test vectors from the behavioral functions of circuits before their implementations are actually executed.

Another advantage of unate circuit implementations is their low chip area. Yet another advantage of unate circuits is their ability to operate at very high speeds. For example, a low-area high-speed circuit implementation known as “domino logic” requires that the boolean function to be implemented be unate. Therefore, binate functions to be implemented in domino logic must be decomposed into unate functions prior to implementation. Similarly, static CMOS logic implementations become efficient if unate functions are extracted from an original binate function prior to implementation. Datapath logic circuits such as adders, subtractors, comparators, and ALUs are good examples of applications where carry generation functions (i.e., unate functions) are extracted from a larger (often binate) function and implemented in high-speed circuit structures.

To meet these and other objects and advantages of the present invention, a method having preferred and alternate embodiments is provided for synthesizing a representation of a circuit into a new representation having greater unateness. The method includes (i) partitioning a circuit representation to obtain a representation of at least one sub-circuit, (ii) recursively decomposing the representation of the at least one sub-circuit into a sum-of-products or product-of-sums representation having greater unateness than the representation of the at least one sub-circuit, and (iii) merging the sum-of-products or product-of-sums representation into the circuit representation to form a new circuit representation.

The invented method may additionally include repeating steps (i), (ii) and (iii) until a desired level of unateness for the new circuit representation has been achieved.

The invented method may additionally include, for each decomposition, selecting the sum-of-products or product-of-sums representation having fewer binate variables.

The invented method may additionally include merging common expressions of the sum-of-products or product-of-sums representations.

The invented method may additionally include implementing algebraic division to merge common unate expressions.

The invented method may additionally include partitioning the circuit representation to obtain a representation of at least one sub-circuit that is highly unate.

The invented method may additionally include implementing a binary decision diagram to recursively decompose the representation of the at least one sub-circuit into the sum-of-products or product-of-sums representation. The binary decision diagram may be a zero-suppressed binary decision diagram.

Additionally, a system having preferred and alternate embodiments is provided for synthesizing a circuit representation into a new circuit representation having greater unateness. The system comprises a computing device configured to (i) receive input defining a circuit representation, (ii) partition the circuit representation to obtain a representation of at least one sub-circuit, (iii) recursively decompose the representation of the at least one sub-circuit into a sum-of-products or product-of-sums representation having greater unateness than the representation of the at least one sub-circuit, (iv) merge the sum-of-products or product-of-sums representation into the circuit representation to form the new circuit representation, and (v) output the new circuit representation.

The computing device may be further configured to receive input defining a desired level of unateness for the new circuit representation, and repeat steps (ii), (iii) and (iv) until the desired level of unateness is achieved.

The computing device may be further configured for each decomposition, select the sum-of-products or product-of-sums representation having fewer binate variables.

The computing device may be further configured to merge common expressions of the sum-of-products or product-of-sums representations.

The computing device may be further configured to implement algebraic division to merge common expressions.

The computing device may be additionally configured to partition the circuit representation to define a representation of at least one sub-circuit that is highly unate.

The computing device may be additionally configured to implement a binary decision diagram to recursively decompose the representation of the at least one sub-circuit into a sum-of-products or product-of-sums representation. The binary decision diagram may be a zero-suppressed binary decision diagram.

The circuit representation and the new circuit representation may be input to the computing device and output from the computing device, respectively, in a hardware description language such as Verilog or VHDL.

Additionally, a preferred computer-readable storage embodiment of the present invention is provided. In accord with this embodiment, a computer-readable storage medium contains computer executable code for instructing one or more computers to (i) receive input defining a circuit representation, (ii) partition the circuit representation to obtain a representation of at least one sub-circuit, (iii) recursively decompose the representation of the at least one sub-circuit into a sum-of-products or product-of-sums representation having greater unateness than the representation of the at least one sub-circuit, (iv) merge the sum-of-products or product-of-sums representation into the circuit representation to form a new circuit representation, and (v) output the new circuit representation.

The computer executable code may additionally instruct the computer(s) to receive input defining a desired level of unateness for the new circuit representation, and repeat steps (ii), (iii) and (iv) until the desired level of unateness is achieved.

The computer executable code may additionally instruct the computer(s) to, for each decomposition, select the sum-of-products or product-of-sums representation having fewer binate variables.

The computer executable code may additionally instruct the computer(s) to merge common expressions of the sum-of-products or product-of-sums representations.

The computer executable code may additionally instruct the computer(s) to implement algebraic division to merge common expressions.

The computer executable code may additionally instruct the computer(s) to employ a binary decision diagram to recursively decompose the representation of the at least one sub-circuit into the sum-of-products or product-of-sums representation.

The above objects and advantages of the present invention are readily apparent from the following detailed description of the preferred and alternate embodiments, when taken in connection with the accompanying drawings.

### BRIEF DESCRIPTION OF THE DRAWINGS

FIGS. 1a-1c are functional circuit diagrams illustrating (a) a single binate block with three functions, (b) two unate blocks with six functions, and (c) three unate blocks with fifteen functions;

FIG. 2 is a block representation corresponding to a decomposition of f(X)=h(g₁(X), g₂(X), . . . , gₖ(X)) in accordance with the present invention;

FIGS. 3a-3b are (a) a binary tree representing an AND-OR decomposition in accordance with the present invention and (b) a corresponding block representation in accordance with the present invention;

FIG. 4 is a block representation corresponding to a k-level AND/OR tree in accordance with the present invention;

FIG. 5 is an example gate-level circuit to be decomposed by the computer-implemented process UDSYN in accordance with the present invention;

FIGS. 6a-6i are (a) a circuit graph G_{C1} for the circuit of FIG. 5, (b) partition Gₚ₁ selected from G_{C1}, (c) unate decomposition performed on G_{P1}, (d) graph G_{C12} obtained by merging B₂ and G_{C1}, (e) partition G_{P2} selected from G_{C2}, (f) final unate decomposition of G_{P2}, (g) circuit graph G_{C3} obtained by merging B₃ and G_{C2}, (h) partition G_{P3} selected from G_{C3}, and (i) final block representation for the circuit of FIG. 5 in accordance with the present invention;

FIGS. 7a-7c illustrate a zero-suppressed binary decision diagram (BDD) representing f₄^{SOP}=ab+\overline{cb}: (a) a path representing cube ab; (b) a path representing cube \overline{cb}; and (c) a zero-suppressed BDD representing f₄^{POS}=(a+\overline{c})(a+\overline{b})(b+\overline{c}) in accordance with the present invention; and

FIGS. 8a-8d illustrate four steps in partitioning G_{C1} of FIG. 6a: (a) start with a primary input node n10 and select n7; (b) select n14 and its transitive fanin nodes; (c) select n18 and its transitive fanin nodes; (d) final partition G_{P1} in accordance with the present invention.

### DETAILED DESCRIPTION OF THE PREFERRED EMBODIMENTS

The present invention comprises a method and system having preferred and alternate embodiments for efficiently synthesizing a representation of a circuit into a new representation having greater unateness.

For purposes of illustration, the present invention is described in the context of Bodean function-based digital circuitry. However, application of the present invention is not so limited. Notably, the present invention may be applied to a variety of circuit representations such as gate-level circuits, PLA representation, transistor-level representations, and HDL-based circuits.

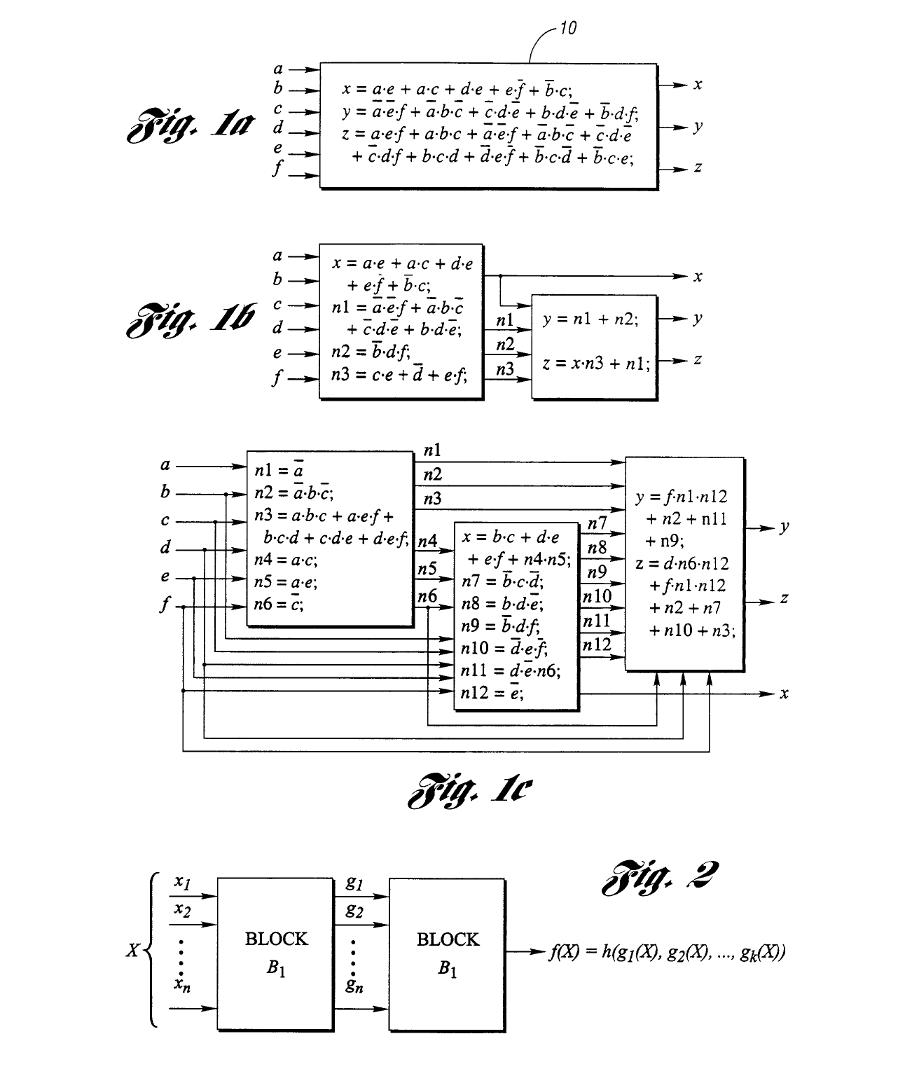

FIG. 1a defines a circuit representation 10 with three binate outputs (e.g., x, y and z). FIG. 1b shows a two-block representation for circuit 10, and FIG. 1c a three-block representation. The block representations of (b) and (c) are obtained by decomposing the functions defining the original single-block circuit representation 10. Circuit functionality for each block is represented in a sum-of-product (SOP) or product-of-sum (POS) form. Table 1 compares the test requirements for the three representations of FIG. 1.

TABLE 1

| | | | Implementation Flexibility | |
|---|---|---|---|---|
| | Test Requirements | | | Area of |
| | No. of Binate | Universal | No. of | an Example |
| Block | Variables for | Test Set | Block | Synthesized |
| Representation | all Functions | Size | Functions | Circuit |
| | 7 | 64 | 3 | 28 |
| | 0 | 33 | 6 | 29 |
| | 0 | 47 | 12 | 50 |

In the case of FIG. 1a, function z is binate for all six variables, so its universal test set consists of all 64 possible test vectors. The decomposed designs of FIGS. 1b and c require smaller universal test sets (33 and 47, respectively), since all their internal blocks are unate. Although the difference in test set size is minor in this small example, it tends to be significant for larger circuits.

Circuits that do not have natural block representations are often implemented by logic synthesis systems, while those with natural block representations are often implemented manually. Although the present invention is not limited to the former case, we assume that the target circuit is of the former type in order to best describe the present invention.

For a given circuit, the block representations created in accordance with the present invention can be considered as design constraints. In other words, the boundaries of the blocks serve as a high-level structural design constraint that must be satisfied by low-level implementations of the circuit such as gate-level or transistor-level implementations. Notably, these design constraints tend to restrict implementation flexibility.

The outputs of any blocks in a circuit C's block representation S_{B} define the block functions. Circuit C's implementation flexibility can be roughly measured by the number of block functions that C employs. This follows from the fact that a large number of block functions in S_{B} implies that the functions themselves are small. Block functions in different blocks cannot be merged, so implementations of small block functions are generally less flexible than large ones. Thus the fewer the block functions in S_{B}, the higher the implementation flexibility of C.

For example, Table 1 compares the implementation flexibility of the block representations in FIG. 1. FIG. 1b has three more block functions than FIG. 1a, while FIG. 1c has 12 more. Whereas FIG. 1a has full implementation flexibility, the other block representations have limited flexibility. The last column of Table 1 compares the area of some example implementations synthesized by a commercial synthesis system Synopsys® Design Compiler with the goal of reducing area. The area is calculated from the relative gate areas defined in the Synopsys cell library; for example, inverter=1, AND2=2, AND4=3, OR2=2, and OR4=3. In summary, this example suggests that lower implementation flexibility often leads to poor implementations in terms of circuit area.

To permit a broad range of implementation styles, the invented synthesis process attempts to decompose a binate function into as small a set of unate subfunctions as possible. In general, a decomposition of function f can be expressed as:

f(X)=h(g₁(X),g₂(X), . . . , gₖ(X))

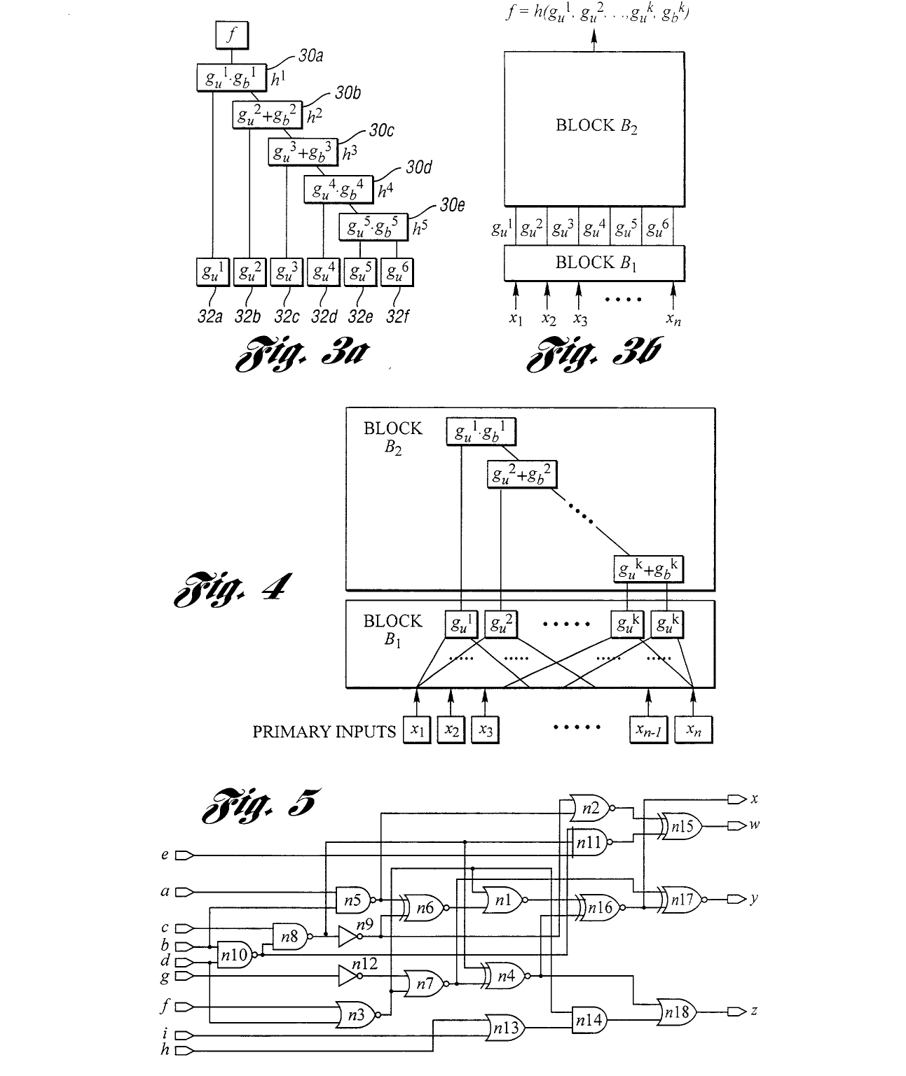

Let f be the root function, subfunction h the parent function, and each subfunction gᵢ a child function. X={x₁, x₂, . . . , xₙ} denotes the support set of f and each gᵢ. A decomposition is called a unate decomposition if all the subfunctions h and g_{1.k} in f(X) are unate. A decomposition of the form f(X) transforms a single-block model of function f into a two-block model with h defining one block and g_{1:k} the other; see FIGS. 2 and 3.

In accordance with the present invention, a preferred method for synthesizing circuits utilizing unateness properties of boolean functions involves recursive OR and AND decompositions of a circuit output function f and its subfunctions. The OR and AND decompositions represent f(X) by h(g₁(X), g₂(X)), where h has the form g₁+g₂ and g₁g₂, respectively. We obtain an OR decomposition off from an SOP form of f, and an AND decomposition from a POS form.

For example, consider a binate function f₁ whose SOP form is a\overline{b}+\overline{a}c+\overline{c}a. A possible OR decomposition of f₁ is h=g₁+g₂ with g₁=\overline{a}c and g₂=a\overline{b}+\overline{c}a. This decomposition makes all the subfunctions h, g₁, and g₂ unate, and so is a unate decomposition. Now consider f₁'s POS form (a+c)(\overline{a}+\overline{b}+\overline{c}). We can obtain directly from this form an AND decomposition with subfunctions h=g₁ g₂, g₁=a+c, and g₂=\overline{a}+\overline{b}+\overline{c}. This is also a unate decomposition.

A single OR or AND decomposition of a large binate function may not lead to a unate decomposition. However, a sequence of OR or AND decompositions applied to f recursively always produces a unate decomposition for any function f The general form of such a sequence with k levels is

f=h¹(g₁¹, g₂¹)

gᵢ¹=h²(g₁², g₂²)

gᵢ^{k-1}=h^{k}(g₁^{k}, g₂^{k})

where h^{j} and gᵢ^{j} denote a parent function and a subfunction, respectively, produced by the j-th level decomposition. Parent function h^{j} can be either AND or OR. A k-level sequence of AND and OR decompositions forms a binary AND-OR tree, where the internal nodes represent AND or OR operations, while the leaf nodes denote unate subfunctions that need no further decomposition.

An arbitrary sequence of AND and OR decompositions can lead to an excessive number of subfunctions. To reduce this number, we restrict our attention to sequences of the following type, which we refer to as unate AND-OR decompositions.

f=h¹(gᵤ¹, g_{b}¹)

g_{b}¹=h²(gᵤ², g_{b}²)

g_{b}^{k-1}=h^{k}(gᵤ^{k}, g_{b}^{k})

As in the general case, h^{j} is either AND or OR, but the final g_{b}^{k} and every gᵤ^{j} are unate, while every gbf except the final one is either unate or binate. This decomposition can also be represented in the compact factored form

f=h¹(gᵤ¹, h² (gᵤ², h³(gᵤ³, . . . , h^{k-1}(gᵤ^{k-1}, h^{k}(gᵤ^{k}, g_{b}^{k}) . . . ))) (1)

as well as the general form

f(X)=h(gᵤ¹, gᵤ², . . . , gᵤ^{k}, g_{b}^{k}) (2)

Comparing (1) with (2), we see that the parent function h in (2) is composed of the AND and OR subfunctions h¹, h², . . . , h^{k} only, and so is always unate.

FIG. 3a shows a binary AND-OR tree corresponding to the unate decomposition

f=(gᵤ¹·(gᵤ²+(g³+(gᵤ⁴·(gᵤ⁵·g_{b}⁵)))))

obtained by a unate AND-OR decomposition with 5 levels. The internal nodes 30a-30 e in FIG. 3a represent AND or OR operations, while the leaf nodes 32a-32f at the bottom represent unate subfunctions. FIG. 3b depicts the block representation corresponding to FIG. 3a. B₁ defines an AND-OR tree network that implements the function h. B₂ is a network of undefined internal representation that implements the unate subfunctions gᵤ¹, gᵤ², gᵤ³, gᵤ⁴, gᵤ⁵, and g_{b}⁵.

In general, we obtain the foregoing kind of unate AND-OR decomposition for f as follows: first decompose f into gᵤ¹ and g_{b}¹ using an AND or OR operation that makes gᵤ¹ unate; then repeatedly decompose g_{b}^{j} into gᵤ^{j+1} and g_{b}^{j+1} in a similar way, until g_{b}^{j+1} becomes unate. This must eventually happen, because a g_{b}^{j} of a single product or sum term is unate. In practice, the AND-OR decomposition process often terminates with a final g_{b}^{j} consisting of a relatively large unate function.

As noted above, the global parent function h(gᵤ¹, . . . , gᵤ^{k}, g_{b}^{k}) in (2) is unate. Thus, the final result of a k-level AND-OR decomposition is a set of k+2 unate subfunctions gᵤ^{1:k}, g_{b}^{k}, and h(gᵤ¹, . . . , gᵤ^{k}, g_{b}^{k})

Notably, an important goal of the block synthesis method shown in FIG. 3 is to find an AND-OR decomposition of a given function f using as few subfunctions as possible. In addition, it is preferred that each gᵤ^{j} be selected in a manner that makes the resulting g_{b}^{j} highly unate. This selection often leads to a unate decomposition involving few subfunctions. Also such a gᵤ^{j} can be relatively easily derived from a standard SOP or POS form.

Each level of a unate AND-OR decomposition is defined by either an AND or OR operation. How we select the operation at each level has a large impact on the final result, as we show with the following example.

Consider f₂=a⊕b⊕c whose SOP and POS forms are given below.

f₂^{SOP}=\overline{ab}c+a\overline{bc}+\overline{a}b\overline{c}+abc (3)

f₂^{POS}=(\overline{a}+b+c(a+\overline{b}+c)(a+b+\overline{c})(\overline{a}+\overline{b}+\overline{c}) (4 )

OR decompositions are derived from (3), and AND decompositions are derived from (4). Suppose we select an OR operation in every level of the decomposition. A possible result is:

f₂=gᵤ¹+(gᵤ²+(gᵤ³+g_{b}³))

which involves five unate subfunctions:

gᵤ¹=\overline{ab}c;

gᵤ²=\overline{a}b\overline{c};

gᵤ³=abc;

g_{b}³=abc; and

h(gᵤ¹,gᵤ²,gᵤ³,g_{b}³)

Note that in this particular example, the unate decomposition is completed when the final g_{b}^{k} is a product term, and the resulting gi subfunctions correspond to each of the product terms in (3).

Next, suppose we select an AND operation in every level. A possible result is the unate decompositions f₂=gᵤ¹·(gᵤ²·(gᵤ³·g_{b}³)), which involves five subfunctions:

gᵤ¹=\overline{a}+b+c;

gᵤ²=a+\overline{b}+c;

gᵤ³=a+b+\overline{c};

g_{b}³=\overline{a}+\overline{b}+\overline{c}; and

h(gᵤ¹,gᵤ²,gᵤ³,g_{b}³).

Notably, a unate decomposition of f₂ can be obtained involving fewer subfunctions if AND and OR operations are mixed as follows. Suppose we select an OR operation in the first level and an AND operation in the second level. The OR operation decomposes (3) into f₂¹=gᵤ¹+g_{b}¹, where gᵤ¹=\overline{ab}c and g_{b}¹=a\overline{bc}+\overline{a}b\overline{c}+abc. To apply an AND operation to g_{b}¹, we use g_{b}¹'s POS form (a+b)(a+\overline{c})(b+\overline{c})(\overline{a}+\overline{b}+c). Then an AND operation leads to g_{b}¹=gᵤ²·g_{b}², where for example, gᵤ²=(\overline{a}+\overline{b}+\overline{c}) and g_{b}²=(a+b)(a+\overline{c})(b+\overline{c}). Since g_{b}² is unate, the unate decomposition is complete. Note that unlike the previous cases, the final g_{b}^{k} here contains more than one term. The third unate decomposition of f₂ is

f₂=gᵤ¹+(gᵤ²·g_{b}²)=\overline{abc}+(\overline{a}+\overline{b}+\overline{c})·(a+b)(a+\overline{c})(b+\overline{c})

which involves only four subfunctions, one less than the first and second cases, where we selected three AND and three OR operations, respectively. This example shows that how we select the AND-OR operation in each level of the AND-OR decomposition is very important.

Often, there are many possible AND and OR decompositions in each level. This implies the existence of a large number of possible unate AND-OR decompositions. For example, if an SOP form of g_{b}^{j} contains m product terms, we can partition these terms into two groups defining gᵤ^{j+1} and g_{b}^{j+1} in 2^{m} different ways. At each level, either an AND or OR operation can be chosen, so the number of possible k-level unate AND-OR decompositions is 2^{m+k}. Thus, finding a unate AND-OR decomposition of a large function f involving a minimal number of subfunctions is often impractical. We therefore introduce Unate-Decomp, a heuristic process that systematically selects AND or OR decompositions at each recursion level, and produces a final unate AND-OR decomposition containing relatively few subfunctions.

Unate-Decomp represents a function f and all its subfunctions in both SOP and POS forms. To produce an AND (OR) decomposition of f, it selects a set S of product terms (sum terms) from the SOP (POS) form of f, so that S constitutes a unate subfunction gᵤ. The rest of the product terms (sum terms) of f define subfunction g_{b}. Unate-Decomp then represents g_{b} by both SOP and POS forms, which it uses to produce an OR and AND decomposition at the next recursion level. To represent SOP and POS forms efficiently, binary decision diagrams can be employed.

To decompose f into as few unate subfunctions as possible, Unate-Decomp produces each gᵤ^{j} in a way that reduces the number of binate variables in g_{b}^{j}. In the case of multiple-function circuits, Unate-Decomp first decomposes each output function fᵢ using the method described above. It then merges common subfunctions of different functions fᵢ and fⱼ to reduce the total number of subfunctions.

Notably, representing large circuits directly by two-level expressions is often inefficient. To handle such cases efficiently, a preferred process first partitions a given circuit, and then performs decomposition on each partition. For example, one partition is created for each process of Unate-Decomp parent function h. The resulting decomposition is then merged into the rest of the circuit. Then the next partition is created from the merged circuit, and the next process of Unate-Decomp is conducted. This process is repeated until no more partitioning is necessary.

Preferably, each decomposition step and circuit partition are selected in a way that produces a small number of highly unate subfunctions. Consequently, the resulting block representations tend to have a high level of implementation flexibility.

To decompose f into as few unate subfunctions as possible, Unate-Decomp produces each gᵤ^{j} in a way that reduces the number of binate variables in g_{b}^{j}. For example, consider the following function f₃:

f₃=\overline{a}b\overline{c}+\overline{a}d+\overline{ae}+b\overline{c}f+bdf+b\overline{e}+\overline{c}df+\overline{ce}+a\overline{b}d\overline{f}+a\overline{b}e+acdf+c\overline{d}f+cd+\overline{d}e

Suppose we decompose f₃ into g_{u+g}_{b}. Table 2 shows some possible ways of doing this and the number of binate variables in the resulting g_{b}.

TABLE 2

| | | No. of |
|---|---|---|
| | | Binate |
| | | Variables in |
| gᵤ | g_{b} | g_{b} |
| cd + acdf + bdf | ad + abe + bcf + cdf + abc + | 6 |
| | abdf + ae + de + cdf + be + | |
| | ce | |
| abdf + ce | ad + abe + bcf + cdf + abc + | 5 |
| | ae + de + cdf + be + cd + | |
| | acdf + bdf | |
| bcf + bdf + cdf + be + | cd + acdf + abe + cdf + | 3 |
| ce + abc + ae | ad + abdf + de | |
| abc + ad + ae + bcf + b | abdf + abe + acdf + | 2 |
| df + be + cdf + ce | cdf + cd + de | |

While the first OR decomposition produces g_{b} with six binate variables, the last OR decomposition produces g_{b} with only two binate variables, and so is selected.

In each level of the decomposition process, Unate-Decomp produces a pair of AND and OR decompositions using a special form of cofactor operation called Subset. The Subset operation for a literal lᵢ extracts a subset S of product (sum) terms of a given SOP (POS) form by eliminating terms that contain lᵢ. For example, applying Subset to the SOP form

\overline{a}bc+a\overline{c}d+a\overline{b}d

for literal

\overline{a}

yields

S=a\overline{c}d+a\overline{b}d

Unate-Decomp systematically computes S for a set of binate literals {l₁} so that S is unate and the set of other terms is highly unate. Then S defines gᵤ^{j}, and the other product terms define g_{b}^{j}.

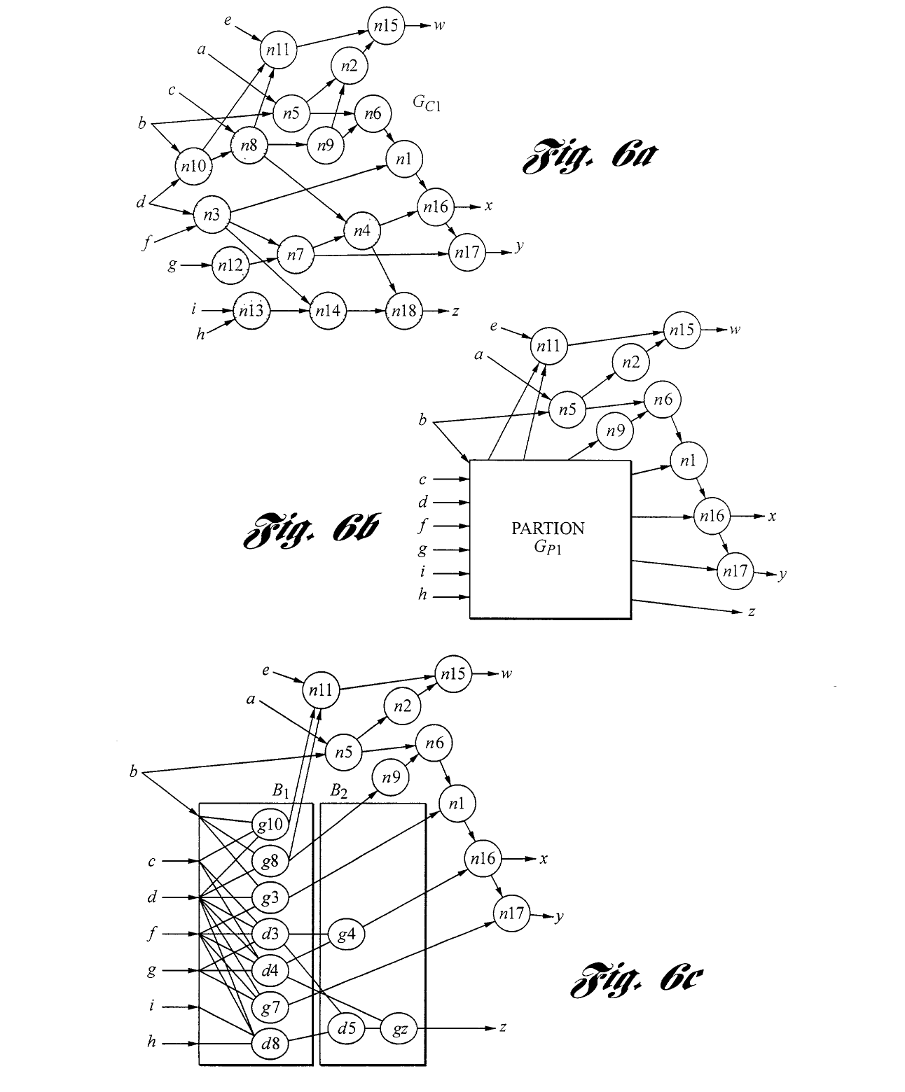

After a unate decomposition is formed, Unate-Decomp constructs two blocks from an AND-OR tree representing the decomposition; see FIG. 4. To ensure that all the block functions are unate, we place in block B₁ all the nodes representing the subfunctions gᵤ^{1:k} and g_{b}^{k}, which correspond to the leaf nodes in the AND-OR decomposition tree. We place in block B₂ all the other nodes, which represent AND and OR operations and together form the function h.

In the preceding description, we focused on decomposing a single function. In the case of multiple-function circuits, Unate-Decomp first decomposes each output function fᵢ using the method described above. It then merges common subfunctions of different functions fᵢ and fⱼ to reduce the total number of subfunctions. Algebraic division operations are often employed by logic synthesis techniques to efficiently combine common expressions. These operations can be easily applied to the results of our AND-OR decompositions, and often reduce the number of subfunctions significantly. Notably, Unate-Decomp incorporates algebraic division in such a manner that two different functions share the divisor of each division.

Based on the unate decomposition concept described above, we introduce a computer-implemented synthesis program in accordance with the present invention called Unate Decomposition Synthesis (UDSYN). Representing large circuits directly by two-level expressions is often inefficient. To handle such cases efficiently, UDSYN first partitions the given circuit, and then performs decomposition on each partition, as generally described above.

Table 3 contains one embodiment of a pseudocode representation of UDSYN in accordance with the present invention. Notably, it is understood by those of ordinary skill in the art that different computer programs and program arrangements can be implemented to support and execute the overall function of UDSYN.

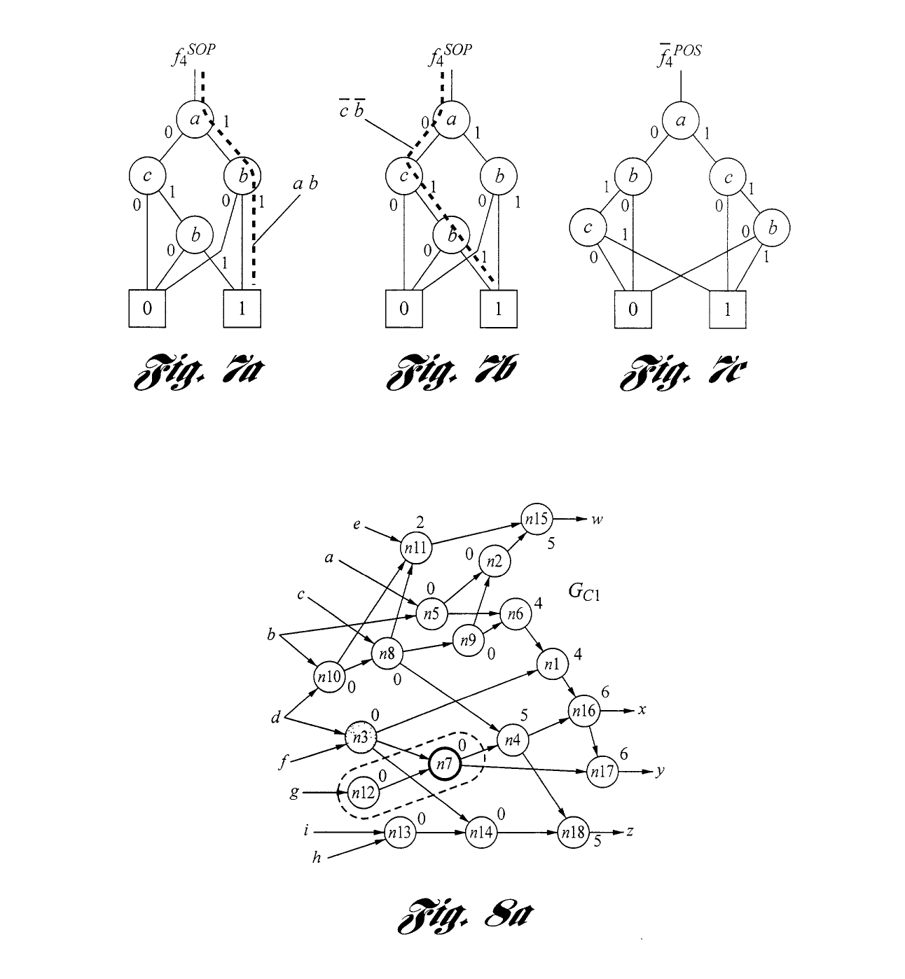

TABLE 3
Embodiment of process UDSYN (Veritog-input)

| | |
|---|---|
| 1: G_{C}: = Build-Circuit-Graph(Verilog-input); | |
| 2: while (G_{C} ≠ Ø) begin | |
| 3: G_{P}: UD-Partition(G_{C}); | /* G_{P} is a graph representing a partitioned block */ |
| 4: G_{C}: = G_{C} − G_{P;} | /* Remove nodes in G_{P} from G_{C} */ |
| 5: for each output node n_{R} in G_{P} begin | |
| 6: Build-ZSBDD(n_{R}, G_{P}); | /* Create SOP and its complement for n_{R} */ |
| 7: end; | |
| 8: (Bᵢ, Bᵢ₊₁): = Unate-Decomp(G_{P}); | /* Bᵢ and Bᵢ₊₁ correspond to B₁ and B₂ of FIG. 7 */ |
| 9: G_{C}: = G_{c} ∪ Bᵢ₊₁; i: = i + 1; | /* Insert notes in Bᵢ₊₁ into G_{C} */ |
| 10: end; | |
| 11: Verilog-output: = Interconnect-Blocks({Bᵢ}); | /* Verilog-output is the final block representation */ |
| 12: return Verilog-output; | |

UDSYN takes an input circuit in a form such as a Verilog specification whose internal elements can be either functional descriptions or gates. First, UDSYN builds a circuit graph G_{c} whose nodes represent the internal elements. It then creates a partition Gₚ of G_{c} using UD-Partition(G_{c}), and removes nodes in Gₚ from G_{c}. The output functions of Gₚ are represented in SOP and POS forms. The process Unate-Decomp(Gₚ) performs unate AND-OR decompositions on the output nodes in Gₚ, and constructs decomposed blocks B₁ and B₂ as in FIG. 4. Blocks B₁ and B₂ created from the i-th partition G_{Pi} are denoted by B₁ and Bᵢ₊₁, respectively. Step 9 modifies G_{c} by inserting all nodes of B₂ into G_{c}. UDSYN repeats the above steps until all nodes in G_{c} are removed. It then constructs a hardware description language (e.g. Verilog, VHDL, etc.) output file by specifying the interconnections among all blocks Bᵢ.

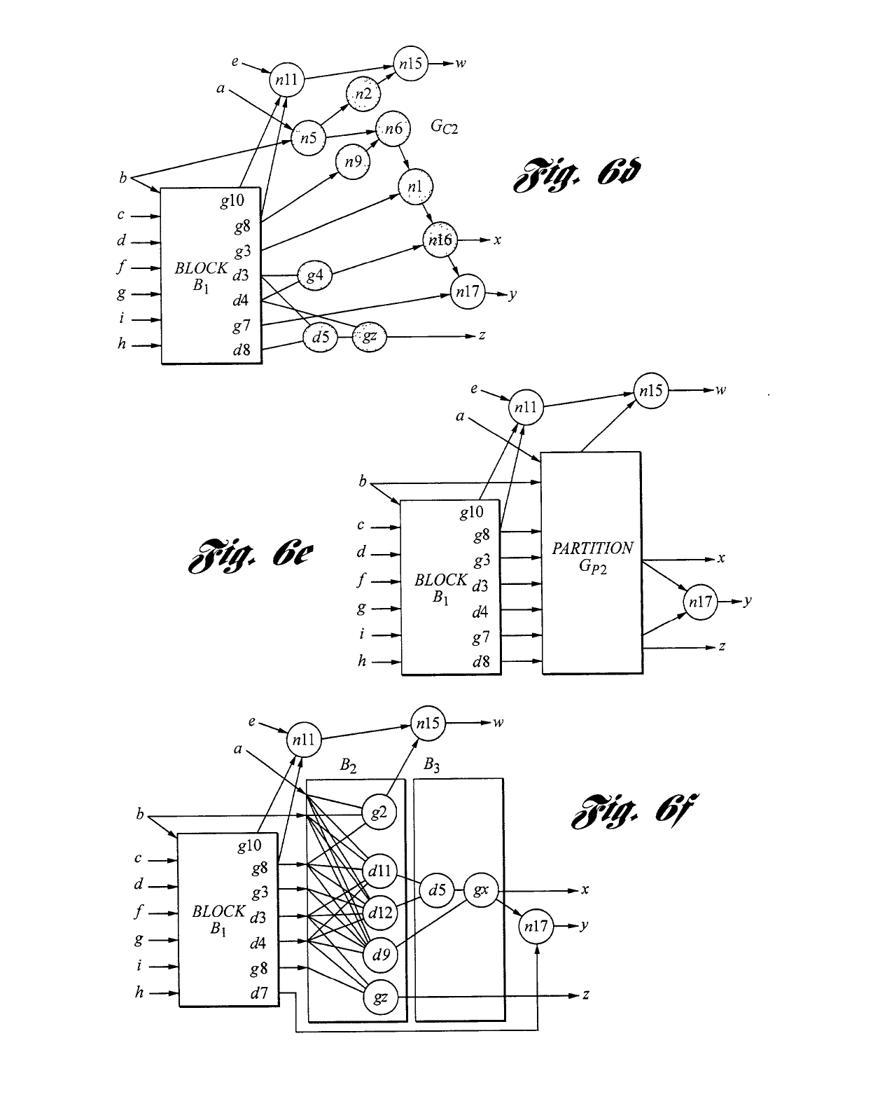

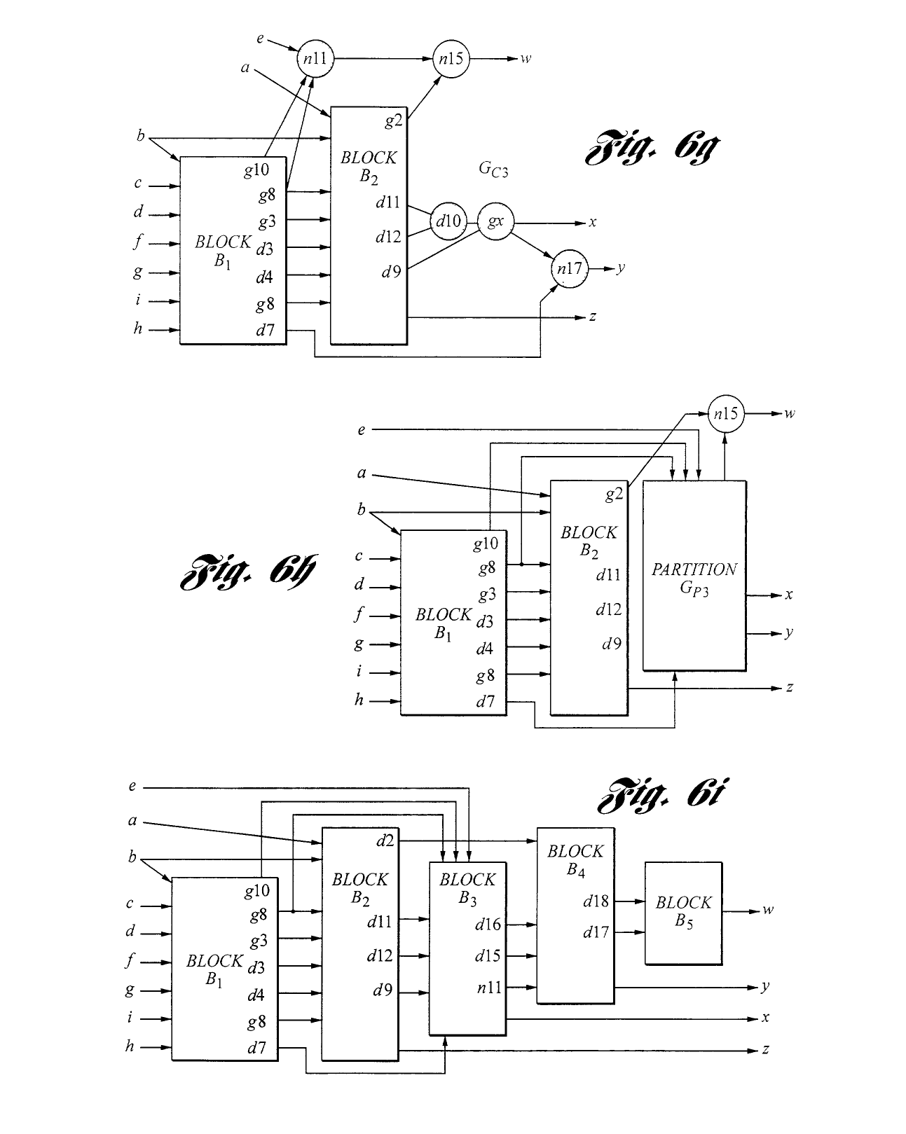

We illustrate UDSYN using a gate-level circuit of FIG. 5 as input. FIGS. 6a to i show intermediate results of steps 2 to 10 in Table 3. FIG. 6a shows the circuit graph G_{C1} for the circuit of FIG. 5; each node in G_{C1} corresponds to a gate in the circuit. UD-Partition(G_{C}) creates a partition G_{P1} starting from the primary inputs of G_{C1}. The shading in G_{C1} indicates nodes that are selected by UD-Partition(G_{C}), and constitute G_{P1}. FIG. 6b represents G_{P1} by a rectangle. All nodes in G_{P1} are removed from G_{C1}, and are merged into SOP and POS forms by steps 5 to 8. These SOP and POS forms are decomposed by step 8 into unate subfunctions; these subfunctions are grouped into two blocks B₁ and B₂ as in FIG. 4. As FIG. 6c shows, B₁ consists of seven subfunctions and B₂ consists of three subfunctions. We create a new circuit graph G_{C2} by merging B₂ and G_{C1} as shown in FIG. 6d. Returning to step 3, UD-Partition(G_{C}) selects some nodes (shaded) in G_{C2} and creates a new partition G_{P2}, which is represented by a rectangle in FIG. 6e. Then step 8 decomposes G_{P2} into blocks B₂ and B₃ appearing in FIG. 6f. Step 9 merges B₃ into a new circuit graph G_{C3} as in the preceding steps; see FIG. 6g. FIG. 6h shows a new partition G_{P3} constructed from G_{C3}. By repeating this process, we finally obtain the decomposed block representation of FIG. 6i consisting of five blocks B_{1.5}. The output functions of these blocks are described by Verilog code in equation form. If UD-Partition(G_{C}) constructs k partitions, UDSYN produces a total of k+1 blocks.

Step 6 of Table 3 uses a type of binary decision diagram (BDD) called a zero-suppressed BDD (ZSBDD) to represent the SOP and POS forms of functions. Although other forms of BDD can be used, we limit our attention in this description to ZSBDDs for the sake of presentation. A ZSBDD of a function f is a graph whose paths denote the product terms (cubes) in an SOP form of f. UDSYN uses two ZSBDDs to represent a pair of SOP and POS forms for the internal function of each node in an AND-OR tree like that in FIG. 4. Thus an AND-OR tree with n nodes is represented by 2n individual ZSBDDs, each of which is linked to the corresponding node in the tree.

For example, FIGS. 7a and b show a ZSBDD representing f₄^{SOP}=ab+\overline{cb}. The internal nodes (circles) in FIGS. 7a and b denote the literals appearing in f₄^{SOP}. The terminal or leaf nodes (rectangles) denote the output values that f₄^{SOP} generates when its literals are set to the values specified on the edges. The name “zero-suppressed” stems from the property that all nodes in a ZSBDD whose 1-edge points to the 1-terminal node are eliminated. Every path from the root to the 1-terminal node represents a cube in f₄^{SOP}. For example, the path highlighted by the dashed line in FIG. 7a represents cube ab, while the one highlighted in FIG. 7b represents cube \overline{cb}. Although ZSBDDs can represent only SOP forms directly, POS forms can also be handled by their complemented form.

For example, consider the POS expression

f₄^{POS}=(a+\overline{c})(a+\overline{b})(b+\overline{c})

having the following complement

\overline{f₄^{POS}}=\overline{a}c+\overline{a}b+\overline{b}c

FIG. 7c shows a ZSBDD that represents \overline{f₄^{POS}}, where every path from the root to the 1-terminal node represents a sum term in f₄^{POS} with their literals complemented. In this way, we can represent both SOP and POS forms using ZSBDDs.

ZSBDDs have been shown to represent large functions efficiently. This is due to the fact that small ZSBDDs can contain a large number of paths, so a large number of cubes can be often represented by a compact ZSBDD. ZSBDDs also support fast manipulation of sets of cubes such as finding subsets, computing the intersection of cube sets, and performing a type of division operation on cube sets. Utilizing these features, we implement unate AND-OR decomposition and division processes that act directly on ZSBDDs.

UD-Partition(G_{C}) creates a partition of the input circuit in a way that makes the functions defining the partition highly unate, while meeting a specified partition size limit. Partitions created in this way simplify the unate decomposition process. One pseudo-code embodiment of UD-Partition appears in Table 4. Notably, it is understood by those of ordinary skill in the art that a variety of different computer programs and program arrangements can be implemented to support and execute the inventive function of UD-Partition.

TABLE 4
Embodiment of process UD-Partition(G_{C})

| | |
|---|---|
| 1: | for each n_{c} in G_{C} on level order begin |

| | |
|---|---|
| 2: | for each fan in node nᵢ of n_{c} begin |

| | |
|---|---|
| 3: | if (nᵢ is a primary input of G_{C}) then |

| | | |
|---|---|---|
| 4: | Sₛᵤₚₚ(n_{c}): = Sₛᵤₚₚ(n_{c}) ∪ nᵢ; | /* Sₛᵤₚₚ(n_{c}) is n_{c}'s support set */ |

| | |
|---|---|
| 5: | else |

| | |
|---|---|
| 6: | Sₛᵤₚₚ(n_{c}): = Sₛᵤₚₚ(n_{c}) ∪ Sₛᵤₚₚ(nᵢ); |

| | | |
|---|---|---|
| 7: | Calculate-Path-Count(Sₛᵤₚₚ)(n_{c})); | /* Add path count of fan-in nodes to n_{c} */ |

| | |
|---|---|
| 8: | end; |

| | | |
|---|---|---|
| 9: | ${N}_{BV} ( {n}_{c} ) = {\sum }_{i = 1}^{k} Binate ( {s}_{i} , {n}_{c} )$ | /* Binate(sᵢ, n_{c}) = 1 if sᵢ is binate for n_{c} */ |

| | |
|---|---|
| 10: | end; |
| 11: | while (G_{C} = Ø) begin |

| | | |
|---|---|---|
| 12: | nₘ: = Select-Node-of-Min-N_{BV}(G_{C}); | /* nₘ is to be included in the partition */ |
| 13: | S_{N}: = nodes in nₘ's fan-in cone in G_{C}; | |
| 14: | if (I/O-count(G_{P} ∪ S_{N}) < threshold) then | /* G_{P} is the graph for the partition */ |

| | | |
|---|---|---|
| 15: | G_{P}: = G_{P} ∪ S_{N}; G_{C}: = : = G_{C} − G_{P}; | /* Add nₘ and its transitive fan-in nodes to G_{P} */ |

| | | |
|---|---|---|
| 16: | else break; | /* Discard the candidate node nₘ */ |

| | |
|---|---|
| 17: | end; |
| 18: | return (G_{C}, G_{P}); |

Steps 1 to 10 compute the number of binate support variables of each node in the circuit graph G_{C}. Steps 11 to 17 create the current partition Gₚ by selecting nodes in G_{C} that have a minimal number of binate variables.

A node n_{c} in G_{C} is unate with respect to a primary input sᵢ, if all paths between n_{c} and sᵢ have the same inversion parity; otherwise, n_{c} is binate with respect to s₁. To determine the inversion parity of the paths, we calculate the number of paths from the primary inputs to each node n_{c} in G_{C}. Let pₑᵥₑₙ(sᵢ, n_{c}) and p_{odd}(sᵢ, n_{c}) be the number of paths from a primary input s₁ to a node n_{c} whose inversion parity is even and odd, respectively. Steps 3 to 7 find the set Sₛᵤₚₚ(n_{c}) of support variables for each node n_{c}. For n_{c} and its fanin nodes n₁, Calculate-Path-Count obtains pₑᵥₑₙ(sᵢ, n_{c}) and p_{odd}(sᵢ, n_{c}) by recursively computing

pₑᵥₑₙ(sᵢ, n_{c})=pₑᵥₑₙ(sᵢ, n_{c})+pₑᵥₑₙ(s₁, n₁)

p_{odd}(sᵢ, n_{c})=p_{odd}(s₁, n_{c})+p_{odd}(sᵢ, n₁)

if the inversion parity from nᵢ to n_{c} is even; otherwise, it computes

pₑᵥₑₙ(sᵢ, n_{c})=pₑᵥₑₙ(s₁, n_{c})+p_{odd}(sᵢ, n₁)

p_{odd}(sᵢ, n_{c})=p_{odd}(sᵢ, n_{c})+pₑᵥₑₙ(sᵢ, n₁).

The binary function Binate(sᵢ, n_{c}) produces 1 (0), if a node n_{c} is binate (unate) with respect to its support variable s₁, and is computed by

Binate(sᵢ, n_{c})=0, if pₑᵥₑₙ(sᵢ, n_{c})=0 or p_{odd}(s₁, n_{c})=0

Binate(sᵢ, n_{c})=1, otherwise

The number N_{BV}(n_{c}) of binate variables of node n_{c} with k variables is defined as

$${N}_{BV} ( {n}_{c} ) = {\sum }_{i = 1}^{k} Binate ( {s}_{i} , {n}_{c} )$$

The intuition behind using N_{BV}(n_{c}) to guide the partitioning stems from the fact that the more binate the node n_{c}, the more difficult the decomposition process for n_{c} tends to be. Steps 1 to 10 traverse every node only once, which has complexity O(N). They propagate pₑᵥₑₙ(sᵢ, n_{c}) and p_{odd}(sᵢ, n_{c}) for every sᵢ for a n_{c} to the nodes in the transitive fanout of n_{c}, which also accounts for complexity O(N). Hence the overall complexity of computing N_{BV}(n_{c}) for all nodes in G_{C} is O(^{N}).

For example, Table 5 shows the calculation of N_{BV}(n_{c}) for every node in FIG. 6a.

TABLE 5

| | | No. of binate |
|---|---|---|
| Node | No. of paths from n_{C}'s support variable sᵢ | variables |
| n_{C} | sᵢ, Pₑᵥₑₙ(Sᵢ,n_{C}), P_{odd}(sᵢ,n_{C})) | N_{BV}(n_{C}) |
| n5 | (a, 0, 1), (b, 0, 1) | 0 |
| n10 | (b, 0, 1), (d, 0, 1) | 0 |
| n3 | (f, 1, 0), (d, 1, 0) | 0 |
| n12 | (g, 0, 1) | 0 |
| n13 | (h, 1, 0), (i, 1, 0) | 0 |
| n8 | (c, 0, 1), (b, 1, 0), (d, 1, 0) | 0 |
| n7 | (g, 1, 0), (f, 0, 1), (d, 0, 1) | 0 |
| n14 | (h, 1, 0), (i, 1, 0), (f, 1, 0), (d, 1, 0) | 0 |
| n9 | (c, 1, 0), (b, 0, 1), (d, 0, 1) | 0 |
| n11 | (b, 1, 1), (d, 1, 1), (c, 1, 0), (e, 0, 1) | 2 |
| n4 | (c, 1, 1), (b, 1, 1), (d, 2, 2), (g, 1, 1), (f, 1, 1) | 5 |
| n2 | (c, 0, 1), (b, 2, 0), (d, 1, 0), (a, 1, 0) | 0 |
| n6 | (a, 1, 1), (b, 2, 2), (c, 1, 1), (d, 1, 1) | 4 |
| n18 | (c, 1, 1), (b, 1, 1), (d, 3, 2), (g, 1, 1), (f, 2, 1), | 5 |
| | (h, 1, 0), (i, 1, 1) | |
| n15 | (c, 2, 2), (b, 4, 4), (d, 3, 3), (a, 1, 1), (e, 1, 1) | 5 |
| n1 | (f, 0, 1), (d, 1, 2), (a, 1, 1), (b, 2, 2), (c, 1, 1) | 4 |
| n16 | (f, 3, 3), (d, 7, 7), (a, 2, 2), (b, 6, 6), (c, 4, 4), | 6 |
| | (g, 2, 2) | |
| n17 | (g, 5, 5), (f, 7, 7), (d, 15, 15), (a, 4, 4), (b, 12, 12), | 6 |
| | (c, 8, 8) | |

The second column lists p_{odd}(sᵢ, n_{c}) and pₑᵥₑₙ(s₁, n_{c}) computed for each node n_{c} and all its support variables. The last column gives N_{BV}(n_{c}). For example, for n_{c}=n11, Binate(b, n11)=1, Binate(d, n11)=1, Binate(c, n11)=0, and Binate(e, n11)=0. Thus N_{BV}(n_{c})=1+1+0+0=2.

After N_{BV}(n_{c}) is computed for every n_{c} in G_{C}, UD-Partition selects from G_{C} a node nₘ of minimal N_{BV}(n_{c}) starting from a primary input of G_{C}. It then inserts into Gₚ all non-partitioned nodes in the transitive fanin region of nₘ. This process is repeated until the size of Gₚ exceeds a threshold equal to the maximum number of Gₚ's I/O lines. By limiting the partition size in this way, we can prevent ZSBDDs from exploding for large circuits, while producing a partition with highly unate output functions.

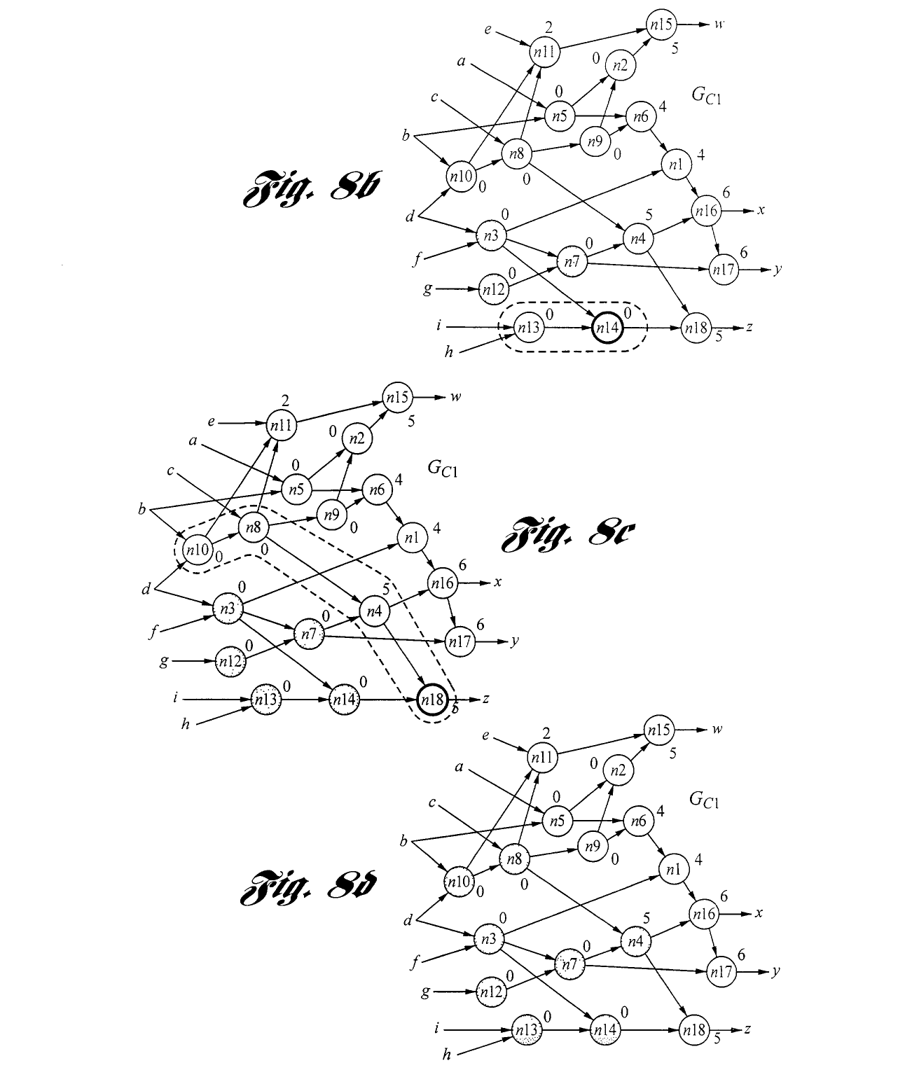

FIG. 8 illustrates how we partition G_{C} of FIG. 6a. Suppose we limit Gₚ's I/O lines to seven inputs and six outputs, that is, we set the threshold to 7/6. The N_{BV}(n_{c}) values calculated in Table 5 are shown next to each node n_{c} in FIG. 8. FIGS. 8a to d indicate the current Gₚ created in each iteration by shading, and newly selected nodes by thick circles. The first nₘ is selected from the candidate nodes n3, n5, n8, n10, n11, n12, and n13, which are adjacent to the primary inputs. We select n3 whose N_{BV}(n_{c}) has the minimum value 0, and add it to Gₚ; see FIG. 8a. The next search begins from n3 and selects n3's fanout node n7 whose N_{BV}(n_{c})=0. We then select all nodes in the transitive fanin region of n7; FIG. 8a indicates these selected nodes by a dashed line. FIG. 8b shows the current Gₚ consisting of n3, n12, and n7. We then select n14 over n1, n14, and n17, and then select n14's fanin node n13; the newly selected nodes are again indicated by a dashed line in FIG. 8b. We next select n17 over n18, n1, n4, but n17 leads to a partition with seven outputs, one greater than the limit six. Hence we select n18 instead which has the next smallest N_{BV}(n_{c}). We then select nodes in n18's transitive fanin region; see FIG. 8c. At this point, the number of I/O lines of Gₚ equals the threshold 7/6, so the partitioning is done. FIG. 8d indicates the final Gₚ by shading.

Since UD-Partition selects nodes with fewer binate variables first, it often leads to a partition where many output functions are already unate and so require no further decomposition. For example, in Gₚ of FIG. 8d, four output functions at n3, n7, n8, and n10 are unate. FIG. 6c shows a unate decomposition of this G_{p,} where nodes g3, g7, g8, and g10 in DI correspond to these four unate functions, and so are not decomposed.

Next we describe Unate-Decomp(G) which systematically applies unate AND-OR decomposition operations to a circuit partition. See Table 6 for one pseudo-code embodiment of Unate-Decomp(G).

TABLE 6
Embodiment of process Unate-Decomp(G)

| | |
|---|---|
| 1: S_{B}: = G's binate function nodes; | /* S_{B} stores nodes of binate functions to be decomposed */ |
| 2: while (S_{B} ≠ Ø) begin | |
| 3: for each node n_{B} in S_{B} begin | |
| 4: (nᵤ, n_{b}): = ANDOR-OneLevel(G, n_{B}); | /* nᵤ (n_{b}) points to subfunction gᵤ (g_{b}) in (3.4) */ |
| 5: S_{D}: = S_{D} ∪ {nᵤ, n_{b}}; | /* S_{D} stores candidate divisor nodes */ |
| 6: end; | |
| 7: for each node n_{d} in S_{D} begin | |
| 8: for each node n_{f} in S_{B} − S_{D} begin | /* n_{f} is a candidate dividend node */ |
| 9: (n_{q}, nᵣ): = Division(n_{f}, n_{d}); | /* n_{q} is the quotient and nᵣ is the remainder */ |
| 10: if (N_{BV}(n_{f}) < N_{BV}(n_{q}) + N_{BV}(nᵣ)) then | |
| 11: Reverse the division; | |
| 12: end; | |
| 13: end; | |
| 14: S_{B}: = Ø; S_{D}: = Ø; | |
| 15: for each node nᵢ in G begin | /* Find new nodes to be decomposed */ |
| 16: if (N_{BV}(nᵢ) > threshold) | |
| 17: S_{B}: = S_{B} ∪ nᵢ; | /* nᵢ exceeds the threshold */ |
| 18: end; | |
| 19: end; | |
| 20: return G; | |

Graph G initially contains the nodes in the current partition. Steps 3 to 6 perform a level of AND-OR decomposition on every binate node n_{B} in G. Then, steps 7 to 13 perform division operations on every binate node in G by treating as divisors child nodes created by the AND-OR decompositions. N_{BV}(nᵢ) denotes the number of binate variables in the subfunction at node n₁ in G. If a division reduces N_{BV}(nᵢ), it is accepted; otherwise, it is discarded. The above process is repeated until all nodes in G become unate. For some large binate functions, forcing all nodes to be unate leads to an excessive number of subfunctions. We therefore stop decomposing a node nᵢ if N_{BV}(nᵢ) becomes less than a certain threshold. This threshold is chosen to yield a small set of subfunctions at the cost of lower unateness. Thus the threshold allows us to trade the level of unateness for a higher implementation flexibility of the block representation.

Table 7 contains a pseudo-code embodiment of the computer-implemented process AND OR-OneLevel(G, n_{B}), which implements one level of the AND-OR decomposition technique described earlier.

TABLE 7
Embodiment of process ANDOR-OneLevel(G, n_{B})

| | |
|---|---|
| 1: (gᵤ^{SOP}, g_{b}^{SOP}): = Find-Unate-Cube-Set (SOP(n_{B})); | /* OR decomposition */ |
| 2: (gᵤ^{CPOS},g_{b}^{CPOS}): = Find-Unate-Cube-Set (Inv(SOP(n_{B}))); | /* AND decomposition */ |
| 3: if (N_{BV}(g_{b}^{SOP}) ≦ N_{BV}(g_{b}^{CPOS})) then | |
| 4: Replace-Node (n_{B}, NewNodes (h^{SOP}, gᵤ^{SOP}, g_{b}^{SOP})); | /* Replace n_{B} in G by the new nodes */ |
| 5: return (Node(gᵤ^{SOP}), Node(g_{b}^{SOP})) | |
| 6: else | |
| 7: Replace-Node (n_{B}, NewNodes(h^{POS}, Inv(gᵤ^{CPOS}), Inv(g_{b}^{CPOS}))); | /* Inv(g) complements g */ |
| 8: return (Node(Inv(gᵤ^{CPOS})), Node(Inv(g_{b}^{CPOS}))); | |

The process Find-Unate-Cube-Set(SOP(n_{B})) finds a set of unate cubes (product terms) from an SOP representation SOP(n_{B}) for node n_{B}. This operation forms an OR decomposition. An AND decomposition is obtained by complementing the input SOP(n_{B}) and the outputs of Find-Unate-Cube-Set, respectively. This enables ZSBDDs to handle both AND and OR decompositions, although ZSBDDs can only represent SOP forms directly.

Table 8 contains a pseudo-code embodiment of the computer-implemented process Find-Unate-Cube-Set(ISOP).

TABLE 8

| | |
|---|---|
| Embodiment of process Find-Unate-Cube-Set (ISOP) | /* ISOP is the initial SOP form */ |

| | |
|---|---|
| 1: | S_{best} := SOP := ISOP; |
| 2: | while (N_{BV}(SOP) > threshold) begin |

| | |
|---|---|
| 3: | for each literal lᵢ for binate variables in SOP repeat |

| | | |
|---|---|---|
| 4: | Sᵢ := Subset(SOP, lᵢ; | /* Remove all cubes containing lᵢ */ |

| | |
|---|---|
| 5: | if (N_{BV}(Sᵢ) + N_{BV}(ISOP − Sᵢ) < N_{BV}(ISOP − S_{best})) then |

| | |
|---|---|
| 6: | S_{best} := Sᵢ; |

| | |
|---|---|
| 7: | end; |
| 8: | SOP := S_{best}; |

| | |
|---|---|
| 9: | end; |
| 10: | gᵤ := S_{best}; |
| 11: | g_{b} := ISOP − S_{best}; |
| 12: | return (gᵤ, g_{b}); |

Find-Unate-Cube-Set(ISOP) derives a cube set S from f's initial SOP form ISOP so that S meets the threshold on N_{BV}(S). As a result, S defines unate subfunction gᵤ^{k} in (1), while ISOP-S defines g_{b}^{k}. As discussed earlier, an exact method to find an optimum AND-OR decomposition of an m-term ISOP must examine up to 2m possible AND decompositions. To avoid this and derive S efficiently, a type of cofactor operation is implemented which can simultaneously extract from ISOP multiple cubes (product terms) with a common property. This operation, denoted by Subset(SOP, lᵢ), removes from SOP all cubes that contain literal lᵢ. Thus lᵢ does not appear in the resulting SOP form Sᵢ, while \overline{l}₁ may appear in Sᵢ; hence S₁ is unate with respect to lᵢ.

For example, consider a function f₅ whose SOP form is

SOP=ab\overline{c}+a\overline{c}d+a\overline{d}+\overline{bd}a+ed

Subset(SOP, d) removes cubes a\overline{d} and \overline{bd}a which contain literal \overline{d}, and yield

Sᵢ=ab\overline{c}+a\overline{c}d+ed

The basic concept is to apply Subset(SOP, lᵢ) to a set of binate literals in a way that makes both S₁ and SOP−Sᵢ highly unate. We found that for a binate lᵢ, Subset(SOP, lᵢ) often eliminates from SOP not only l₁, but also other binate literals. Hence we can often obtain a highly unate cube set S by repeating only a few steps of Subset(SOP, l₁). The inner loop (steps 3 to 8) of Table 8 performs Subset(SOP, l₁) for all binate literals l₁, and selects S_{best}, (i.e., the S₁ having the minimum N_{BV}(S₁)+N_{BV}(ISOP−Sᵢ)). The outer loop (steps 2 to 9) repeats this process recursively with S_{best} in place of SOP until N_{BV}(S_{best}) becomes less than threshold. The final S_{best} defines gᵤ, while ISOP-S_{best} defines g_{b}.

To illustrate, consider an initial SOP form

ISOP=ab\overline{c}+a\overline{c}d+a\overline{d}+\overline{bd}a+ec+\overline{a}bde+ed

Suppose that the threshold of N_{BV} is 0. Table 9 shows each step of the outer loop in its first iteration with ISOP assigned to SOP.

TABLE 9
SOP = ISOP = abc + acd + ad + bda + ec + abde + ed

| Binate | | | N_{BV}(Sᵢ) + |
|---|---|---|---|
| literal lᵢ | Sᵢ | ISOP − Sᵢ | N_{BV}(ISOP − Sᵢ) |
| a | bc + abde + ed | abc + acd + ad + bda | 3 |
| a | abc + acd + ad + bda + | abde | 3 |
| | bc + ed | | |
| b | ad + bda + ed + bc | abc + acd + abde | 2 |
| b | abc + acd + ad + ed + abde | bda + bc | 2 |
| c | abc + acd + ad + bda + abde | bc | 2 |
| c | ad + bda + abde + bc | abc + acd | 3 |
| d | abc + ad + bda + bc | acd + abde | 3 |
| d | abc + acd + ed + abde + bc | ad + bda | 3 |

Each row in Table 9 shows Sᵢ and ISOP−Sᵢ obtained by Subset(SOP, lᵢ) for binate literals lᵢ=a,\overline{a},b,\overline{b},c,\overline{c},d and \overline{d} of ISOP. Row 3 (i.e. binate literal b) gives the minimum N_{BV}(S₁)+N_{BV}(SOP−Sᵢ) and so is selected. The selected S₁ is still binate, so the second iteration of the outer loop is performed with the S₁ assigned to SOP; see Table 10. Each row gives Subset(SOP, l₁) for binate literals l₁=d and \overline{d}in SOP.

TABLE 10
SOP = S_{best} = ad + bda + ed + bc

| Binate | | | N_{BV}(Sᵢ) + |
|---|---|---|---|
| literal lᵢ | Sᵢ | ISOP − Sᵢ | N_{BV}(ISOP − Sᵢ) |
| d | ad + bda + bc | ed + abc + acd + abde | 1 |
| d | ed + bc | ad + bda + abc + | 3 |
| | | acd + abde | |

The first row (i.e. literal d) of Table 10 gives the lower N_{BV}(Sᵢ)+N_{BV}(SOP−Sᵢ), and is selected. The selected Sᵢ now is unate and so the process is done. We finally obtain gᵤ=a\overline{d}+\overline{bd}a+\overline{b}c and g_{b}=ed+ab\overline{c}+a\overline{c}d+\overline{a}bde. Since Find-Unate-Cube-Set(ISOP) aims to reduce both N_{BV}(Sᵢ) and N_{BV}(SOP−S₁), it tends to make g_{b} highly unate as well. Observe that the g_{b} produced in this example is unate for all but one variable (a).

The Subset(SOP, l₁) operation conducted using an M-node ZSBDD has a complexity of O(M). Find-Unate-Cube-Set(ISOP) for an ISOP with N binate variables repeats the inner loop N² times. Hence the worst case complexity of Find-Unate-Cube-Set(ISOP) is O(N²M). Compare this with the complexity 0(2^{m}) of an exact method discussed above; m is usually significantly greater than N and M. Thus the presented AND-OR decomposition process can generate highly unate gᵤ^{j} and g_{b}^{j} quite efficiently.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for synthesizing a circuit representation into a new circuit representation having greater unateness, the method comprising:
(i) partitioning the circuit representation to obtain a representation of at least one sub-circuit;
(ii) recursively decomposing the representation of the at least one sub-circuit into a sum-of-products or product-of-sums representation having greater unateness than the representation of the at least one sub-circuit; and
(iii) merging the sum-of-products or product-of-sums representation into the circuit representation to form a new circuit representation.

2. The method of claim 1 additionally comprising repeating steps (i), (ii) and (iii) until a desired level of unateness for the new circuit representation has been achieved.

3. The method of claim 1 wherein the sum-of-products or product-of-sums representation selected for each decomposition is the representation having fewer binate variables.

4. The method of claim 1 additionally comprising merging common expressions of the sum-of-products or product-of-sums representations.

5. The method of claim 4 wherein algebraic division is implemented to merge common unate expressions of the sum-of-products or product-of-sums representation.

6. The method of claim 1 wherein the circuit is a digital circuit.

7. The method of claim 1 wherein the representation of the at least one sub-circuit is highly unate.

8. The method of claim 1 wherein a binary decision diagram is employed to recursively decompose the representation of the at least one sub-circuit into the sum-of-products or product-of-sums representation.

9. The method of claim 8 wherein the binary decision diagram is a zero-suppressed binary decision diagram.

10. A system for synthesizing a circuit representation into a new circuit representation having greater unateness, the system comprising a computing device configured to:
(i) receive input defining the circuit representation;
(ii) partition the circuit representation to obtain a representation of at least one sub-circuit;
(iii) recursively decompose the representation of the at least one sub-circuit into a sum-of-products or product-of-sums representation having greater unateness than the representation of the at least one sub-circuit;
(iv) merge the sum-of-products or product-of-sums representation into the circuit representation to form the new circuit representation; and
(v) output the new circuit representation.

11. The system of claim 10 wherein the computing device is additionally configured to:
receive input defining a desired level of unateness for the new circuit representation; and
repeat steps (ii), (iii) and (iv) until the desired level of unateness is achieved.

12. The system of claim 10 wherein the computing device is additionally configured to, for each decomposition, select the sum-of-products or product-of-sums representation having fewer binate variables.

13. The system of claim 10 wherein the computing device is additionally configured to merge common expressions of the sum-of-products or product-of-sums representations.

14. The system of claim 13 wherein the computing device is additionally configured to implement algebraic division to merge common expressions.

15. The system of claim 10 wherein the circuit is a digital circuit.

16. The system of claim 10 wherein the representation of the at least one sub-circuit is highly unate.

17. The system of claim 10 wherein the computing device is additionally configured to employ a binary decision diagram to recursively decompose the representation of the at least one sub-circuit into the sum-of-products or product-of-sums representation.

18. The system of claim 17 wherein the binary decision diagram is a zero-suppressed binary decision diagram.

19. The system of claim 10 wherein the circuit representation and the new circuit representation are input and output in a hardware description language.

20. A system for synthesizing a circuit representation into a new circuit representation having greater unateness, the system comprising:
(i) a means for receiving input defining the circuit representation;
(ii) a means for partitioning the circuit representation to obtain a representation of at least one sub-circuit;
(iii) a means for recursively decomposing the representation of the at least one sub-circuit into a sum-of-products or product-of-sums representation having greater unateness than the representation of the at least one sub-circuit;
(iv) a means for merging the sum-of-products or product-of-sums representation into the circuit representation to form the new circuit representation; and
(v) a means for outputting the new circuit representation.

21. The system of claim 20 additionally comprising:
a means for receiving input defining a desired level of unateness for the new circuit representation; and
a means for repeating steps (ii), (iii) and (iv) until the desired level of unateness is achieved.

22. The system of claim 20 additionally comprising a means for selecting, for each decomposition, the sum-of-products or product-of-sums representation having fewer binate variables.

23. The system of claim 20 additionally comprising a means for merging common expressions of the sum-of-products or product-of-sums representations.

24. The system of claim 20 additionally comprising a means for implementing algebraic division to merge common expressions.

25. The system of claim 20 additionally comprising a means for partitioning the circuit representation such that the representation of the at least one sub-circuit is highly unate.

26. The system of claim 20 additionally comprising a means for employing a binary decision diagram to recursively decompose the representation of the at least one sub-circuit into the sum-of-products or product-of-sums representation.

27. The system of claim 26 wherein the binary decision diagram is a zero-suppressed binary decision diagram.

28. The system of claim 20 wherein the circuit representation and the new circuit representation are input and output in a hardware description language.

29. A computer-readable storage medium containing computer executable code for instructing one or more computers to:
(i) receive input defining a circuit representation;
(ii) partition the circuit representation to obtain a representation of at least one sub-circuit;
(iii) recursively decompose the representation of the at least one sub-circuit into a sum-of-products or product-of-sums representation having greater unateness than the representation of the at least one sub-circuit;
(iv) merge the sum-of-products or product-of-sums representation into the circuit representation to form a new circuit representation; and
(v) output the new circuit representation.

30. The computer-readable storage medium of claim 29 wherein the computer executable code additionally instructs the computer(s) to:
receive input defining a desired level of unateness for the new circuit representation; and
repeat steps (ii), (iii) and (iv) until the desired level of unateness is achieved.

31. The computer-readable storage medium of claim 29 wherein the computer executable code additionally instructs the computer(s) to, for each decomposition, select the sum-of-products or product-of-sums representation having fewer binate variables.

32. The computer-readable storage medium of claim 29 wherein the computer executable code additionally instructs the computer(s) to merge common expressions of the sum-of-products or product-of-sums representations.

33. The computer-readable storage medium of claim 32 wherein the computer executable code additionally instructs the computer(s) to implement algebraic division to merge common expressions.

34. The computer-readable storage medium of claim 29 wherein the circuit is a digital circuit.

35. The computer-readable storage medium of claim 29 wherein the representation of the at least one sub-circuit is highly unate.

36. The computer-readable storage medium of claim 29 wherein the computer executable code additionally instructs the computer(s) to employ a binary decision diagram to recursively decompose the representation of the at least one sub-circuit into the sum-of-products or product-of-sums representation.

37. The computer-readable storage medium of claim 36 wherein the binary decision diagram is a zero-suppressed binary decision diagram.

38. The computer-readable storage medium of claim 29 wherein the circuit representation and the new circuit representation are input and output in a hardware description language.
